(19) United States
(12) Patent Application Publication
(10) Pub. No.: US 2025/0033070 A1
(43) Pub. Date: Jan. 30, 2025

(54) Electronic Atomizing Device

(71) Applicant: Shanghai QV Technologies Co., Ltd., Pudong New Area, Shanghai (CN)

(72) Inventors: Xiaogang Deng, Shanghai (CN); Xiaofeng Peng, Oakville, ON (CA)

(21) Appl. No.: 18/713,221

(22) PCT Filed: Nov. 22, 2022
(86) PCT No.: PCT/CN2022/133569

§ 371 Date: May 24, 2024

(30) Foreign Application Priority Data
Nov. 26, 2021 (CN) 202111420823.6

(51) Int. Cl. B05B 11/00

(52) U.S. Cl. CPC B05B 11/0054; B05B 11/0002

(57) ABSTRACT

This invention provides an electronic atomizing device characterized in that it comprises a shell, a bottom cover, an atomizing element bracket, an atomizing element assembly, and an electrode; the shell comprises a suction nozzle and a mounting part; the shell and the bottom cover form the first empty cavity, where the atomizing element bracket and atomizing element assembly are located; the electrode is installed in the bottom cover; the first cavity also includes a first air passage; the upper part of the first air passage is connected with the suction nozzle, and a liquid storage is formed between the outer wall of the first air passage and the inner wall of the shell; the atomizing element bracket is a “ [symbol] ” at the bottom of the first air passage, and is provided with an opening atop; the opening is connected with the first air passage and forms an air-tight connection; an atomizing element installation groove is arranged below the atomizing element bracket; the shoulders of the “ [symbol] ” form the entrance of atomizing liquid channel; the atomizing element assembly is arranged in the atomizing element installation groove, the lower part of which is connected with the upper end of the electrode.

This invention generally relates to an atomizing device, in particular to an atomizer module and an electronic atomizing device which includes the atomizer module.

### BACKGROUND ART

The atomization of this invention refers to atomizing a liquid into an aerosol which can be inhaled by people through the mouth and nose. Atomization is widely used in electronic cigarettes, medical and recreational products, etc. but current atomizing devices generally have the following problems:
The liquid down-flowing passage of the liquid storage chamber is too long and narrow, and this is easy to cause the problem of insufficient supply of atomizing liquid;
The atomizing device contacts the battery rod which is prone to be oxidized or covered by liquor condensate after a long time, resulting in poor electrical contact. And the atomizing device is unstable and easy to shake;
The air channel is not designed reasonably, thus affecting the user experience. The atomizing device and the battery rod do not form a closed air channel. When the atomized aerosol is exchanged with the air outside, squeaking is prone to appear in the gap between the atomizer and the battery rod;
The atomizing chamber is too large and does not match the front and rear air passages. As a result, the aerosol cannot be effectively taken out of the atomizing chamber when in use, and thus resulting in excessive condensate;
It is difficult to assemble the oil cup with the atomizing assembly because the seal between there constitutes an interference fit and there is no guide groove.

### DETAILS OF THIS INVENTION

In view of the shortcomings of the prior art, the present invention aims to provide an electronic atomizing device characterized in that it comprises a shell, a bottom cover, an atomizing element bracket, an atomizing element assembly, and an electrode; The shell comprises a suction nozzle and a mounting part; The shell and the bottom cover form the first empty cavity, where the atomizing element bracket and atomizing element assembly are located; The electrode is installed in the bottom cover; The first cavity also includes a first air passage; The upper part of the first air passage is connected with the suction nozzle, and a liquid storage chamber is formed between the outer wall of the first air passage and the inner wall of the shell; The atomizing element bracket is a “ [symbol] ” at the bottom of the first air passage, and is provided with an opening atop; The opening is connected with the first air passage and forms an air-tight connection; An atomizing element installation groove is arranged below the opening; The shoulders of the atomizing element bracket form the entrance of atomizing liquid channel; The atomizing element assembly is arranged in the atomizing element installation groove, and the lower part of which is connected with the upper end of the electrode.

Preferably, a first sealing ring is arranged between the suction nozzle and the mounting part in the electronic atomizing device.

Preferably, the atomizing element assembly comprises a sealing sleeve, a flow stabilizing cotton, and a heating element; The heating element is arranged under the flow stabilizing cotton and constitutes an interference fit with the cotton; The sealing sleeve wraps the stabilizing cotton and the heating element; The upper part of the sealing sleeve is provided with an atomizing liquid inlet, and is in sealed contact with the atomizing element bracket in the electronic atomizing device.

Preferably, a rigid middleware is arranged between the flow stabilizing cotton and the sealing sleeve in the electronic atomizing device.

Preferably, the outer wall of the atomizing element bracket is provided with a buckle, and the side wall of the bottom cover is provided with a buckle hole in the electronic atomizing device.

Preferably, the electrode is a crown spring terminal, which comprises a second cavity inside, the crown spring is arranged in the second cavity, and the crown spring protrudes inward and has elastic strain outward in the electronic atomizing device.

Preferably, the crown spring terminal constitutes an interference fit or is threaded with the mounting hole on the bottom cover in the electronic atomizing device.

Preferably, the lower part of the crown spring terminal is connected with the bottom cover under riveting pressure, or is riveted, or is buckled together in the electronic atomizing device.

Preferably, the bottom cover also comprises a convex platform, where a condensate absorbing cotton is set; In the mounting state, the upper surface of the condensate absorbing cotton is pressed and fixed by the bottom surface of the atomizing element bracket in the electronic atomizing device.

Preferably, the side wall of the bottom cover comprises a groove, and a second sealing ring is arranged in the groove in the electronic atomizing device.

Preferably, the atomizing element bracket comprises a bracket seal and a bracket; The bracket comprises a downward inclined atomizing liquid guiding surface; The part of the seal in contact with the bracket is provided with an elastic sealing gasket in the electronic atomizing device.

Preferably, the outer wall of the seal also comprises a circular arc shaped sealing framework in the electronic atomizing device.

Preferably, a second air passage is arranged on the side wall of the bracket, the upper opening of the second air passage is covered by the sealing gasket, and the lower opening of the second air passage is open in the electronic atomizing device.

Preferably, the second air passage is arranged in a “ [symbol] ” shape in the electronic atomizing device.

Preferably, an atomizing chamber is formed between the lower part of the atomizing element bracket, the inner wall of the shell and the bottom cover, and the caliber of the atomizing chamber is greater than that of the opening in the electronic atomizing device.

Preferably, the inner wall of the shell is provided with an inclined plane and in the shell, the inner diameter above the inclined plane is smaller than the inner diameter below the inclined plane in the electronic atomizing device.

Preferably, the bottom cover is also provided with an air inlet in the electronic atomizing device.

The electronic atomizing device of this invention has a shorter and wider atomizing liquid channel, especially the design of the atomizing element bracket in the preferred mode of execution, which makes the atomizing liquid reach the flow stabilizing cotton more easily, and the air in the liquid storage chamber can be timely supplemented, so as to avoid the problem of insufficient liquid supply. The design of seal and condensate absorbing cotton on the atomizing liquid channel avoids the leakage of atomizing liquid, and the reasonable design of air passage makes the mixing and exchange of atomizing liquid and air more efficient and improves the using effects.

### INTRODUCTION TO THE DRAWINGS

FIG. 1 is an exploded view of the embodiment of this invention;

FIG. 2a is a profile view of the embodiment in FIG. 1 along A-A in the assembled state;

FIG. 2b is a profile view of the embodiment in FIG. 1 along B-B in the assembled state;

FIG. 3 is an exploded view of a preferred embodiment of the atomizing element assembly;

FIG. 4 is an exploded view of the bottom cover, electrode, and related parts;

FIG. 5 is an exploded view of a preferred mode of embodiment of the atomizing element bracket;

FIG. 6 is a profile view of the atomizing element bracket in FIG. 5; and

FIG. 7 is a stereogram of the bracket in the embodiment of FIG. 5.

### EMBODIMENTS

The execution of this invention is explained by specific embodiments below, and a person in this art can easily understand other advantages and effects of this invention from the details disclosed herein. The invention can also be implemented or applied in other different ways, and the details herein can also be modified or changed in various ways based on different views and applications without deviating from the spirit of this invention.

Please refer to the attached drawings then. To be sure, the drawings provided in this embodiment are only explaining the basic conception of this invention, and thus do not show the actual number, size and shape of the component put into practice but only showing the component associated with the invention; The type, number and proportion of the components actually put into practice can be a random change, and the component layout pattern may also be more complex. Unless otherwise specified, the words “up”, “down”, “left” and “right” used herein are all from the perspective of the observer in the attached drawing.

The atomizing device of this invention comprises a liquid storage chamber, an atomizing element and other key components, which are used to form a complete atomizing equipment after being assembled with a battery rod. The battery rod generally refers to the other parts of the atomizing equipment except the atomizing device. And one of its functions is to power up the atomizing equipment after being assembled with the atomizing device. Since the battery rod is not the innovative point of this invention, the structure of the battery rod is not introduced in this invention.

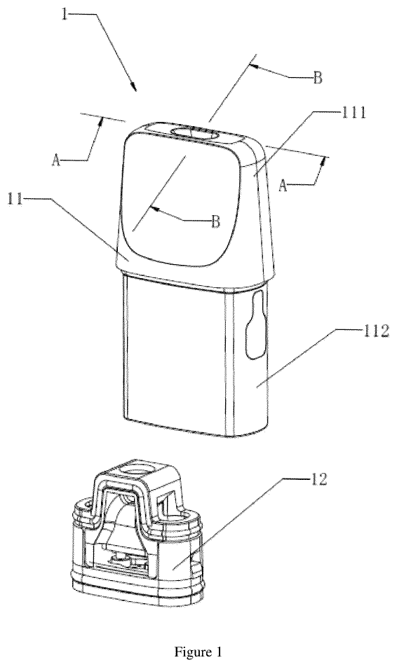

Firstly, please refer to FIG. 1, an exploded view of the embodiment of this invention. Atomizing device 1 includes shell 11 and bottom cover 12. Shell 11 is composed of two parts. The upper part is suction nozzle 111, and the lower part is assembling part 112. Suction nozzle 111 is the exit of aerosol for direct aspiration by the user with mouth and nose or other kinds of aspirator. Assembling part 112 is used to connect to the battery rod (not shown).

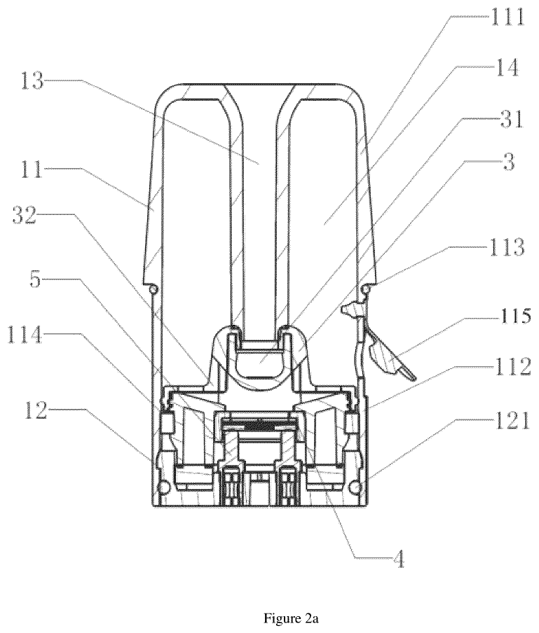

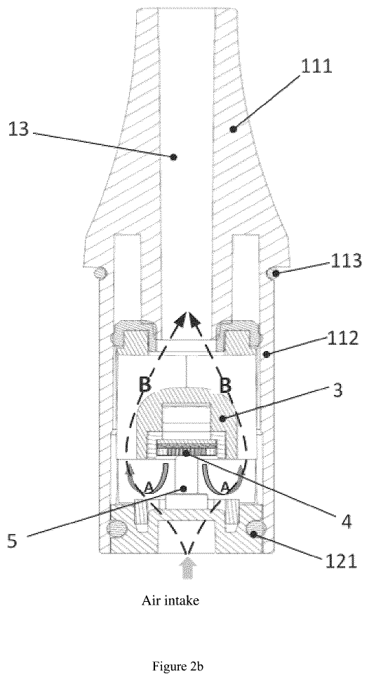

In this embodiment, atomizing device 1 is plugged into the battery rod, so assembling part 112 is slightly smaller than the joint of upper and lower parts by outer diameter. Preferably, scaling ring 113 is set at the joint of upper and lower parts of shell 11, and forms an air-tight seal between atomizing device 1 and the battery rod to avoid air leakage, so that the air from outside can fully mix with atomizing liquid, problems like whistlers resulted from leak in the gap and insensitive pneumatic switch are also being avoided, the connection of atomizing device and the battery rod is being stabilized, so the shake of atomizing device after installation is avoided. Shell 11 and bottom cover 12 define an internal cavity, which encapsulates the atomizing element, liquid storage chamber, air passage, etc. See FIGS. 2a and 2b below for an illustration of each part.

FIG. 2a is a longitudinal profile of the embodiment in FIG. 1 along A-A in the assembled state. There is air passage 13 in the cavity, the upper part of the air passage is connected with the suction nozzle, and liquid storage chamber 14 is formed between the outer wall of air passage 13 and shell 11 for storing atomizing liquid. Atomizing element bracket 3 is set below air passage 13 and has a convex shape like the Chinese character “ [symbol] ”, where there is an opening 31 on top. Opening 31 is connected with air passage 13 and forms an air-tight connection. For example, the upper part of bracket 3 is set with a silica gel pad, which is in contact with the lower part of air passage 13 to form an air-tight connection. The atomizing element installation groove is arranged below bracket 3 to accommodate atomizing element assembly 4. The shoulders of “ [symbol] ” shaped bracket 3 form inlet 32 of the atomizing liquid channel and connect to atomizing element assembly 4, so that atomizing liquid in liquid storage chamber 14 can directly reach atomizing element assembly 4. With PG (propylene glycol) and VG (vegetable glycerin) as the main compositions, atomizing liquid is quite sticky, and the “ [symbol] ” shaped atomizing element bracket 3 expands the entrance of atomizing liquid channel, shortens the atomizing liquid channel, improves the passing ability of atomizing liquid, and alleviates the problem of liquid feeding shortage compared with the ordinary flat design.

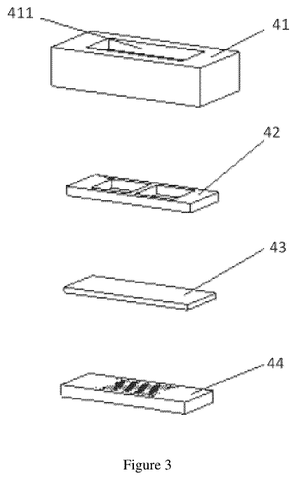

Preferably, the inner wall of shell 11 is set as a structure with a small upper end and a large lower end, and the inner diameter of the shell above interface 114 is smaller than the inner diameter below. Such a design can play a guiding role in the assembly of atomizing element bracket 3 and the bottom cover 12 to facilitate the assembly and be more conducive to setting the seal to form a seal. Refer to FIG. 3 for the implemented structure of atomizing element assembly 4 of the invention, which comprises sealing sleeve 41, flow stabilizing cotton 43 and heating unit 44. Heating unit 44 is arranged under and in contact with flow stabilizing cotton 43, and constitutes an interference fit with the cotton so that the atomizing liquid in flow stabilizing cotton 43 is heated and the liquid is atomized. Sealing unit 41 can be made from silica gel, which covers flow stabilizing cotton 43 and heating unit 44, and the upper part is sealed with the atomizing element bracket and has inlet 411 for atomizing liquid so that the atomizing liquid can only reach flow stabilizing cotton 43 below through inlet 411 for atomizing liquid. Preferably, rigid middleware 42 is arranged between flow stabilizing cotton 43 and sealing sleeve 41 to ensure that sealing sleeve 41 above and flow stabilizing cotton 43 below remain flat and undeformed.

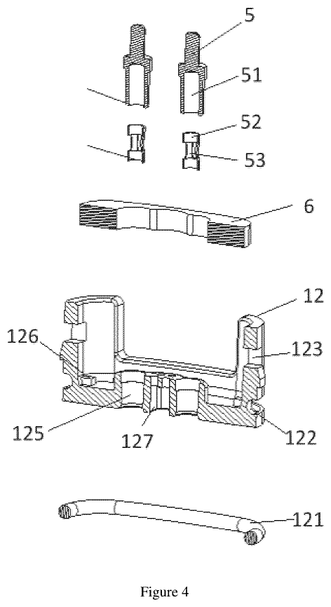

Electrode 5 is arranged below atomizing element assembly 4 and installed on bottom cover 12. See FIG. 4 for details of their structure and assembly relation. FIG. 4 is an exploded view of bottom cover 12, electrode 5, and related parts.

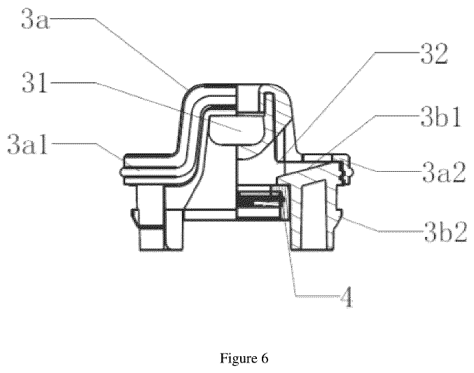

In order to make the atomizing element bracket more stable, buckle hole 123 can be set above the side wall of bottom cover 12 to match with buckle hole 3b2 on atomizing element bracket 3 (see FIG. 6) upon installation. Electrode 5 adopts a crown spring terminal, which includes cavity 51 inside, and there is crown spring 52 inside cavity 51. Crown spring 52 bulges inward and can have elastic strain outward. Electrode 5 designed with crown spring terminal has larger contact area and tighter contact, compared with the contact point, when it fits with the electrode in the battery rod, avoiding poor electrode contact and improving reliability. Terminal 5 and mounting hole 125 on bottom cover 12 constitute an interference fit with the lower part of terminal 5, and are connected with bottom cover 12 under riveting pressure; After installation, the lower part of terminal 5 is flush with the lower surface of bottom cover 12.

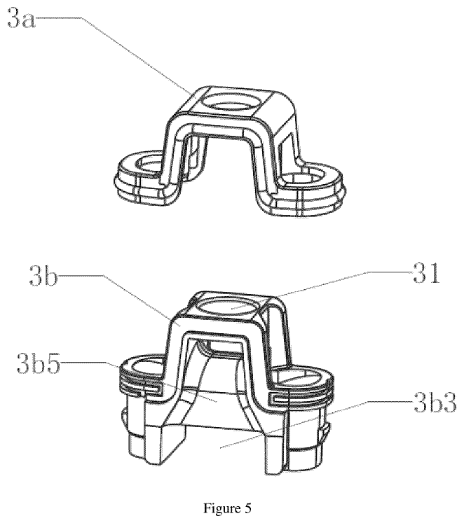

Bottom cover 12 also includes convex platform 126 for placing condensate absorbing cotton 6. Upon installation, the upper surface of condensate absorbing cotton 6 is pressed and fixed by the bottom surface of atomizing element bracket 3. Condensate absorbing cotton 6 is used to absorb condensed aerosols and water vapor. The side wall of bottom cover 12 includes groove 122 for mounting sealing ring 121, which constitutes an interference fit with the inner surface of installation part 112 to form a seal, further ensuring that the atomizing liquid and condensate do not leak. Air inlet 127 is arranged under bottom cover 12. When negative pressure is generated from the suction nozzle due to suction, the outside air enters the atomizing device, is mixed with the aerosol generated after atomization, and is discharged through air passage 13 and the suction nozzle from the atomizing device. Arranging air inlet 127 under bottom cover 12 can make the atomizing device more compact and the air passage more reasonable. In the mode of execution that does not pursue this effect, the air inlet can be arranged on the shell.

Whereas air needs to be added into the liquid storage chamber timely with the decrease of atomizing liquid, otherwise negative pressure will be excessive in the liquid storage chamber and fluid feeding may also be affected, atomizing element bracket 3 falls into two parts, as shown in FIG. 5˜7, and includes bracket seal 3a atop and bracket 3b below in a more preferred mode of execution of the present invention. See FIG. 6˜7 for detailed structures of bracket seal 3a and bracket 3b.

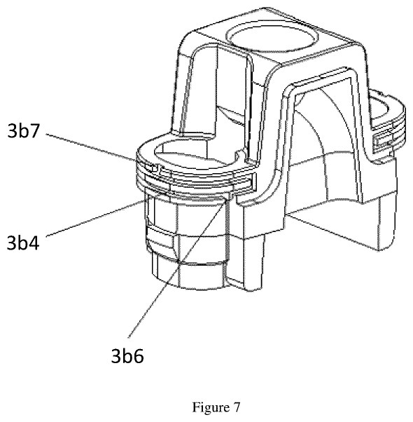

FIG. 6 is a profile view of atomizing element bracket 3 and FIG. 7 is a stereogram of atomizing element bracket 3. Bracket seal 3a includes seal framework 3al with circular arc shaped cross section protruding on the surface of seal 3a, and forming a seal with the inner wall of installation part 112 upon interference fit after assembly to avoid the leakage of atomizing liquid. The part of seal 3a in contact with bracket 3b is provided with an elastic scaling gasket 3a2 of silica gel or rubber to form a seal. There is liquid guiding surface 3b1 extending at an incline downward to help expand the atomizing liquid channel and guarantee sufficient liquid supply.

The design of “ [symbol] ” shaped bracket 3b makes the caliber of atomizing chamber 3b3 below greater than that of opening 31 atop, namely, the caliber of air passage 13. An inclined plane is arranged in front and/or behind bracket 3b to form aerosol channel 3b5 between opening 31 and atomizing chamber 3b3. In addition, the lower end of aerosol channel 3b5 is large, and the upper end is small. During suction, the flow accelerates in air passage 13, and the vent of the air passage is under greater negative pressure due to the Venturi effect, thus enabling more aerosol to enter air passage 13 and reducing liquid condensates. The aerosol channel during suction is shown by arrow A in FIG. 2b. And the air channel is shown by arrow B in FIG. 2b.

More preferably, air passage 3b4 is set on the side wall of bracket 3b. Upper opening 3b7 of air passage 3b4 is covered by sealing gasket 3a2, and lower opening 3b6 is open to ensure that air can be replenished into the liquid storage chamber in time when there is less atomizing liquid in the liquid storage chamber. More preferably, air passage 3b4 is set to have a return or labyrinth shape like Chinese character “ [symbol] ”, which lengthens air passage 3b4 and narrows the caliber of the air passage at the same time, so that even if a small amount of atomizing liquid leaks into the air passage through opening 3b5, it cannot flow out of the air passage due to the viscosity of the atomizing liquid so as to avoid the leakage of atomizing liquid.

In summary, the atomizing device of the invention has a shorter and wider channel for atomizing liquid to enter the atomizing element assembly from the liquid storage chamber, especially the design of the atomizing element bracket in the preferred mode of execution, which makes it easier for atomizing liquid to reach the flow stabilizing cotton, and the air in the liquid storage chamber timely replenished to avoid the problem of insufficient liquid supply. The design of the seal and condensate absorbing cotton on the atomizing liquid channel avoids the leakage of atomizing liquid. At the same time, the reasonable design of the air channel makes atomized aerosol fully mix with the air and improves the effects in use.

The above embodiments are illustrative only of the principle and effectiveness of the invention and are not intended to limit the invention. Any person who is familiar with the technique may modify or alter the above embodiments without prejudice to the spirit and scope of the invention. For example, liquid injection port 115 (see FIG. 2) is set up on the shell to add atomizing liquid in the above embodiments, but this shall not constitute a limitation of the patent. The scheme of the present invention also applies to enclosed atomizing device and disposable atomizing device or oil filling port of the location set differently from the embodiment hereof since the change is the conventional choice in the field, but doesn't require creative work; The atomizing device of this invention is plugged with the battery rod, but this is not necessary, and a variety of known connection methods such as thread and snap can also be adopted; The size ratio of the suction nozzle and the installation part can also be changed since these changes do not affect the technical effect of this invention; The riveting connection between crown spring terminal 5 and bottom cover 12 can also be replaced by a threaded connection; In this embodiment, air is exchanged through a suction nozzle between the atomizing device and the outside world by suction. In some applications, it can also be exchanged by injecting air into an air intake or exhausting air from a suction nozzle, and this shall be regarded as equivalent one to the scheme of the present invention. Therefore, all equivalent modifications or changes made by those with common sense in the technical field to which the invention belongs without prejudice to the spirit and technical ideas revealed by the invention shall still be covered by the claims of the invention.

1. An electronic atomizing device characterized in that it comprises
a shell, a bottom cover, an atomizing element bracket, an atomizing element assembly, and an electrode;
the shell comprises a suction nozzle and a mounting part;
the shell and the bottom cover form the first cavity, where the atomizing element bracket and atomizing element assembly are located; the electrode is installed in the bottom cover;
the first cavity also includes a first air passage; the upper part of the first air passage is connected with the suction nozzle, and a liquid storage is formed between the outer wall of the first air passage and the inner wall of the shell;
the atomizing element bracket has a “ [symbol] ” at the bottom of the first air passage, and is provided with an opening atop; the opening is connected with the first air passage and forms an air-tight connection; An atomizing element installation groove is arranged below the opening; the shoulders of the “ [symbol] ” form entrances of atomized liquid channel;
the atomizing element assembly is arranged in the atomizing element installation groove, and the lower part of which is connected with the upper end of the electrode.

2. The electronic atomizing device mentioned in claim 1 is characterized in that a first sealing ring is arranged between the suction nozzle and the mounting part.

3. The electronic atomizing device mentioned in claim 1 is characterized in that the atomizing element assembly comprises a sealing sleeve, a flow stabilizing cotton, and a heating element; The heating element is arranged under the flow stabilizing cotton and constitutes an interference fit with the cotton; The sealing sleeve wraps the stabilizing cotton and the heating element; The upper part of the sealing sleeve is provided with an atomized liquid inlet, and is in sealed contact with the atomizing element bracket.

4. The electronic atomizing device mentioned in claim 3 is characterized in that a rigid middleware is arranged between the flow stabilizing cotton and the sealing sleeve.

5. The electronic atomizing device mentioned in claim 1 is characterized in that the outer wall of the atomizing element bracket is provided with a buckle; The side wall of the bottom cover is provided with a buckle hole.

6. The electronic atomizing device mentioned in claim 1 is characterized in that the electrode is a crown spring terminal, which comprises a second cavity inside, the crown spring is arranged in the second cavity, and the crown spring bulges inward and has elastic strain outward.

7. The electronic atomizing device mentioned in claim 6 is characterized in that the crown spring terminal constitutes an interference fit or is threaded with the mounting hole on the bottom cover.

8. The electronic atomizing device mentioned in claim 6 is characterized in that the lower part of the crown spring terminal is connected with the bottom cover under riveting pressure, or is riveted, or is buckled together.

9. The electronic atomizing device mentioned in claim 1 is characterized in that the bottom cover also comprises a convex platform, where a condensate absorbing cotton is set; In the mounting state, the upper surface of the condensate absorbing cotton is pressed and fixed by the bottom surface of the atomizing element bracket.

10. The electronic atomizing device mentioned in claim 1 is characterized in that the side wall of the bottom cover comprises a groove, and a second sealing ring is arranged in the groove.

11. The electronic atomizing device mentioned in claim 1 is characterized in that the atomizing element bracket comprises a bracket seal and a bracket; The bracket comprises a downward inclined atomized liquid guiding surface; The part of the seal in contact with the bracket is provided with an elastic sealing gasket.

12. The electronic atomizing device mentioned in claim 11 is characterized in that the outer wall of the seal also comprises a circular arc shaped sealing framework.

13. The electronic atomizing device mentioned in claim 11 is characterized in that a second air passage is arranged on the side wall of the bracket, the upper opening of the second air passage is covered by the sealing gasket, and the lower opening of the second air passage is open.

14. The electronic atomizing device mentioned in claim 13 is characterized in that the second air passage is arranged in a “ [symbol] ” shape.

15. The electronic atomizing device mentioned in claim 1 is characterized in that an atomizing chamber is formed between the lower part of the atomizing element bracket, the inner wall of the shell and the bottom cover, and the caliber of the atomizing chamber is greater than that of the opening.

16. The electronic atomizing device mentioned in claim 1 is characterized in that the inner wall of the shell is provided with an interface, and in the shell, the inner diameter above the interface is smaller than the inner diameter below the inclined plane.

17. The electronic atomizing device mentioned in claim 15 is characterized in that there is inclined plane in the front and/or back of the atomizing element bracket so that an aerosol channel is formed between the opening and the atomizing chamber, and the lower end of the aerosol channel is large and the upper end is small.

18. The electronic atomizing device mentioned in claim 1 is characterized in that the bottom cover is also provided with an air inlet.
